(19) United States
(12) Patent Application Publication
(10) Pub. No.: US 2007/0279332 A1
(43) Pub. Date: Dec. 6, 2007

(54) Display Activated by the Presence of a User

(76) Inventors: Christopher James Newton Fryer, Cambridge (GB); Duncan Robert Johnston, Cambridge (GB)

Correspondence Address: FENWICK & WEST LLP, SILICON VALLEY CENTER, 801 CALIFORNIA STREET, MOUNTAIN VIEW, CA, 94041, US

(21) Appl. No.: 10/598,156

(22) PCT Filed: Feb. 18, 2005
(86) PCT No.: PCT/GB05/00604

§ 371 Date: Apr. 10, 2007

(30) Foreign Application Priority Data
Feb. 20, 2004 (GB) 0403853.5

(51) Int. Cl. G09G 3/30

(52) U.S. Cl. 345/76

(57) ABSTRACT

A display, typically an electroluminescent display, of the type having both an activated, “on”, state and an inactivated, “off”, state, and being switchable between the two, which display incorporates a capacitance sensor, able to detect the near presence of a user, together with means able to utilise the output of this sensor to effect activation of the display accordingly. Preferably, the capacitance sensor comprises a pair of electrodes, one of which may be a front electrode of the electroluminescent display. The capacitance may be sensed by determining the time taken to charge a capacitance; the capacitance may be charged at two or more rates so as to decrease the time taken to measure the capacitance and so reduce the energy consumed.

This invention is concerned with improved displays, and relates in particular to devices with displays that are activated by the mere presence of a User of the device. More specifically still, the invention is concerned with displays, such as electroluminescent displays, that are most preferably switched off, to conserve power, when not in use, and employ capacitance sensing means to detect a nearby User and so enable activation ready for use.

Certain materials are electroluminescent—that is, they emit light, and so glow, when an electric field is generated across them. The first known electroluminescent materials were inorganic particulate substances such as zinc sulphide, while more recently-found electroluminescent materials include a number of small-molecule organic emitters known as organic LEDs (OLEDS) and some plastics—synthetic organic polymeric substances—known as light-emitting polymers (LEPs). Inorganic particulates, in a doped and encapsulated form, are still in use, particularly when mixed into a binder and applied to a substrate surface as a relatively thick layer; LEPs can be used both as particulate materials in a binder matrix or, with some advantages, on their own as a relatively thin continuous film.

This electroluminescent effect has been used in the construction of displays. In some types of these a large area of an electroluminescent material—generally referred to in this context as a phosphor—is provided to form a backlight which can be seen through a mask that defines whatever characters the display is to show. In other types there are instead individual small areas of EL material. These displays have many applications; examples are a simple digital time and date display (to be used in a watch or clock), a mobile phone display, the control panel of a household device (such as a dishwasher or washing machine), and a hand-holdable remote controller (for a television, video or DVD player, a digibox, or a stereo or music centre).

A problem with electroluminescent displays is that they are rather profligate with power; another is that they have a relatively short life—possibly as little as 1000 hours. Accordingly, when they are used the device of which they are a part is normally arranged to turn the display off when it is not required. This means, of course, that when their use is required they must first be activated, or turned on, and while it is perfectly possible for the User him- or herself manually to achieve this it would be advantageous were the display to be turned on automatically. It is this, the automatic activation of the display, that the present invention seeks to facilitate. And in order to attain this end the invention proposes that the display—or, rather, the controlling circuitry with which the display is associated—be able to use capacitance effects to determine the near presence of the User, and specifically of the User's hand as the device is picked up, and to utilise this to effect activation of the display.

In one aspect, therefore, this invention provides a display of the type having both an activated, “on”, state and an inactivated, “off”, state, and being switchable between the two, which display incorporates a capacitance sensor, able to detect the near presence of a User, together with means able to utilise the output of this sensor to effect activation of the display accordingly.

The display can be of any sort, and used with any variety of device. It could, for instance, be a light-emitting diode (LED) display, or it could be a backlit liquid crystal display (an LCD) or even a thin film transistor (TFT) display as used in computer screens. However, the invention is of particular value when applied to displays using electroluminescent materials to provide the light output, which displays need to be switched off when not in use in order to conserve power and extend their useful working life. A typical such electroluminescent display is that employed in a remote (hand-held) controller for, say, a television.

In the invention the display—by which term is here meant the combination of the actual display together with its controlling circuitry—incorporates is a capacitance sensor, able to detect the near presence of a User. In this context a capacitance sensor is, in effect, little more than a pair of spaced electrodes plus suitable electronics able to measure the capacitance of the pair and to output some sort of signal in dependence thereon. The pair's capacitance is determined by the size of the electrodes, by the distance between them, and by the electrical nature of the medium between them; a near body, particularly such a body at earth/ground potential (such as the User's hand), will strongly affect the latter, and the resulting change in capacitance, and relevant output signal, can be sufficient to allow its use for switching the display, as required.

Where the capacitance sensor does indeed utilise a pair of electrodes, then these can be positioned anywhere suitable relative to the display. Where the display of the device in question is an electroluminescent display, and such a display has, as is usual, a front electrode for activating the display's light-emitting areas, then one electrode of the pair is most conveniently that front electrode, the other being either the case of the device or one of the power terminals of the circuit driving and controlling the device and its display. The ground (earth) terminal is a preferred choice, particularly if the case is grounded, as—in a hand-held device such as a remote controller, for example—this will couple to the User holding the device better than other parts of the system. The use of the front electrode of the display removes the need to add extra electrodes to the system specifically for the purpose of capacitance sensing; however, if preferred an extra electrode can be added specifically for the purpose of making the capacitance measurement.

For displays which operate with the front electrode at a high voltage, some protection—a suitable diode, for instance—can be added to safeguard the sensor electronics therefrom when the display is operating.

The invention employs a capacitance sensor able to detect the near presence of a User. More specifically, the sensor detects a change in the capacitance of a pair of spaced electrodes that is effected when a User either picks up the device of which the display is a part and/or touches the display panel. The capacitance may either increase or decrease, depending on the design of the device in question, and the electrodes between which the capacitance is measured. In an example discussed in more detail hereinafter, the capacitance increases.

The display of the invention incorporates a capacitance sensor together with means able to utilise the output of this sensor to effect activation of the display accordingly. In general, the manner in which the sensor's output is used to effect display activation may be any that is convenient. However, one particular method involves measuring the time taken to charge the capacitance to a specific value (a threshold value; this threshold level could be the threshold level of an input into a microcontroller, a comparator or any other suitable device). Clearly, the bigger the capacitance the longer it takes, and by frequently discharging and then charging the capacitance, and comparing the charging times, so there can quite simply be determined when—as by picking up the device—a User has come near to the display.

To explain this in more detail the invention is now described as the measurement of a test capacitance between the front electrode of a display device and the ground point of the device. As noted, the system for measuring the test capacitance involves charging the test capacitance under the control of a microprocessor, and making a measurement of the time taken for the voltage on the test capacitance to reach a threshold level.

For battery powered applications it is preferable to minimise the power consumption of the capacitance measurement system in order to maximise battery life. As the test capacitance will be very small, it will not require a large amount of charge to reach the threshold voltage, so this is not an important consideration in reducing power consumption (indeed, the power consumption of the microcontroller device used to control the capacitance measurement in the period over which the measurement is made will usually be greater than the power consumed in charging the capacitance!). The critical issue is to make the measurement as quickly as possible, and therefore reduce power consumption, while also making an accurate measurement which can distinguish small changes in the test capacitance. In order to achieve this, a system of two or more charge rates may be used. By way of example, a system using two charge rates—the dual ramp system—is described here.

The test capacitance is first charged at a high rate for a fixed period of time chosen so as rapidly to charge the capacitance to a voltage close to the threshold voltage in a very short time (within, for example, 1 to 50 microseconds). The capacitance is then charged at a significantly lower rate until the required threshold voltage is reached (the rate of the slow ramp determines the variation in capacitance which can be distinguished by timing of the slow ramp). The time taken for the slow ramp charge period thus to charge the capacitance gives a measurement of the size of the capacitance.

The microcontroller filters the time taken for the slow ramp to charge the capacitance to the threshold voltage, taking the average of a number of measurements in order to reduce noise. A large change in the slow ramp time, i.e. a change that is larger than the usual level of random noise in the capacitance measurement, will indicate a change in the test capacitance due to the presence of a User's hand or the like, and cause the microcontroller to activate the device. If the test capacitance increases, then the time for the slow ramp will increase, and if the test capacitance decreases then the slow ramp time will decrease.

In order to minimise the time for the test, and therefore to minimise power consumption, the time period for the fast ramp is adjusted by feedback from the slow ramp time. If the slow ramp time takes longer than a predetermined time, then the fast ramp time is increased by one time quantisation. This reduces the time the microprocessor is running for, and therefore reduces power consumption.

If the voltage threshold is reached on the test capacitance before the fast ramp has finished then the time period for the fast ramp needs to be decreased in order to bring the trigger point into the slow ramp period.

In summary, then, the invention relates to devices incorporating displays, particularly electroluminescent displays, which are able to sense when they have been picked up or touched by a User, this functionality enabling the display panel of the device only to be active when the device is required by the User. Application of the invention preferably involves apparatus for making a measurement of the capacitance between two electrodes, particularly in a way such that power consumption is minimised (for battery-powered devices, in particular). The two electrodes used can be, for example, the front electrode of the display and either the case of the device or one of the power terminals of the device circuitry (the ground (earth) terminal is preferred for this, as this will couple to the User holding the device better than will other parts of the system). The electrode capacitance will be affected when a User either picks up the device and/or touches its display panel (the capacitance may either increase or decrease, depending on the design of the device in question, and the electrodes between which the capacitance is measured). If possible, the use of the front electrode of the display removes the need to add extra electrodes to the system specifically for the purpose of capacitance sensing, though of course an extra electrode can be added if desirable.

An embodiment of the invention is now described, though by way of illustration only, with reference to the accompanying diagrammatic Drawings in which:

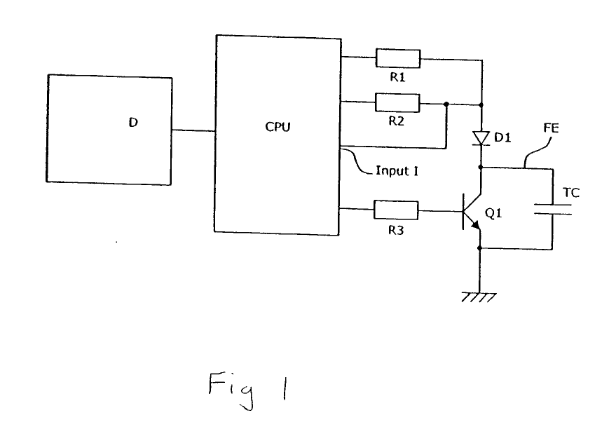

FIG. 1 shows, mostly in block form, a circuit diagram of a display system using a capacitance sensing system according to the invention;

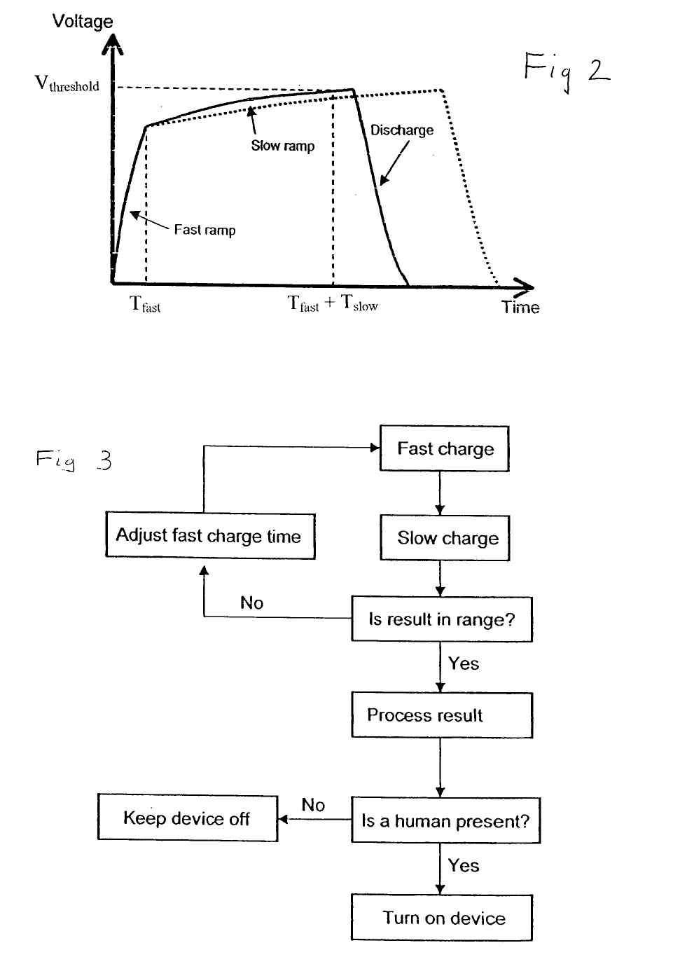

FIG. 2 shows a graph representing the voltage in the sensing system of FIG. 1 on the test capacitance against time; and

FIG. 3 shows a flow chart showing the flow of system operation for the sensing circuit of FIG. 1.

FIG. 1 shows a circuit diagram of a display system using a capacitance sensing system according to the invention. The diagram indicates the test capacitance (TC) to be measured, two resistors (R₁, R₂) for charging the test capacitance, a protection diode (D₁), a transistor (Q₁) for discharging the test capacitance (with a resistor [R₃] for controlling the discharge current), the input (I) for testing for the threshold voltage, a microcontroller (CPU) for processing measurements, and the display (D) to be activated when a User is detected. The front electrode (FE) of the display is labelled for the case when it is used as one of the electrodes.

FIG. 2 shows a graph representing the voltage in the sensing system of FIG. 1 on the test capacitance against time, while FIG. 3 is a flow chart showing the flow of system operation for the sensing circuit. The operation of the sensing system is now explained.

The test capacitance TC—here the capacitance between the display's front electrode FE and Ground/earth—is first charged through a resistance R₁ (typically 100 kOhms) for a fixed period of time. This time period (T_{fast}) is chosen so as to charge the test capacitance TC to a voltage close to the threshold voltage V_{threshold} within a short period of time (typically between 1 and 50 micro seconds). The test capacitance TC is then charged at a slower rate through a larger resistance R₂ (typically 5 MOhms), until the required threshold voltage is reached.

The time (T_{slow}) taken for the slow ramp charge period to charge the test capacitance to the threshold voltage as measured at input I gives a measurement of the capacitance of the test capacitance. The rate of the slow ramp determines the variation in capacitance which can be distinguished by timing of the slow ramp.

The microcontroller CPU filters the time T_{slow} taken for the slow ramp to charge the test capacitance to the threshold voltage. This is done by taking the average of a number of measurements in order to reduce noise. A large change in the slow ramp time—i.e. a change that is larger than the usual level of random noise in the capacitance measurement—indicates a change in the test capacitance TC due to the presence of a human hand or the like (not shown), and causes the microcontroller to activate the device (the display D of which the sensing system forms a part). If the test capacitance TC increases, then the time T_{slow} for the slow ramp will increase, and if the test capacitance decreases then the slow ramp time will decrease.

In order to minimise the time for the test, and therefore also to minimise power consumption, the time period T_{fast} for the fast ramp is adjusted by feedback from the slow ramp time T_{slow}. If the slow ramp time takes longer than a predetermined time, then the fast ramp time is increased by one time quantisation in order to reduce the time the microprocessor is running for, and therefore to reduce power consumption.

If the voltage threshold V_{threshold} is reached on the test capacitance before the fast ramp has finished, then the time period T_{fast} for the fast ramp needs to be decreased in order to bring the trigger point into the slow ramp period.

After a measurement has been made, a transistor (Q₁) is used to pull all of the charge out of the test capacitance in order to ensure it is fully discharged before the next measurement is made. Resistor R₃ controls the current used in this discharge. Diode D₁ is included to protect the microcontroller from the high voltages present on the front electrode FE when the display D is in operation.

1. A display of the type having both an activated, “on”, state and an inactivated, “off”, state, and being switchable between the two, which display incorporates a capacitance sensor, able to detect the near presence of a user, together with circuitry arranged to utilise the output of this sensor to effect activation of the display accordingly.

2. A display according to claim 1, in which the display comprises an electroluminescent display.

3. A display according to claim 1, in which the capacitance sensor comprises a pair of spaced electrodes and electronics arranged to measure the capacitance of the pair and to output a signal in dependence thereon.

4. A display according to claim 2, in which the electroluminescent display comprises a front electrode arranged to activate light-emitting areas of the electroluminescent display, and in which one of the pair of electrodes of the capacitance sensor is the front electrode.

5. A display according to claim 4, in which the other of the pair of electrodes forms one of a case of the display and a power terminal of a circuit arranged to drive and control the display.

6. A display according to claim 5 in which the power terminal is a ground terminal.

7. A display according to claim 4 in which a diode is provided to protect the capacitance sensor or means to effect activation from a voltage present at the front electrode.

8. A display according to claim 1, in which the capacitance sensor comprises a capacitance and the display is arranged to detect the time taken to charge the capacitance to a specific value.

9. A display according to claim 8, in which the display is arranged to charge the capacitance at two or more charging rates.

10. A display according to claim 9, in which the display is arranged to charge the capacitance at a first rate for a first period of time so as to charge the capacitance to close to a threshold voltage, followed by a second, significantly slower, rate, until the threshold voltage is reached.

11. A display according to claim 10, in which the display is arranged to detect a change in the time taken to reach the threshold voltage to indicate the presence of a user.

12. A display according to claim 10, in which the display is arranged to adjust the first period of time by feedback from the time taken to charge the capacitance to the threshold voltage.

13. A electroluminescent display of the type having both an activated, “on”, state and an inactivated, “off”, state, and which is arranged to be switched between the two states, in which the display incorporates a capacitance sensor comprising a pair of spaced electrodes and electronics arranged to measure the capacitance of the pair and to output a signal in dependence thereon, wherein one of the pair of electrodes is a front electrode arranged to activate light-emitting areas of the electroluminescent display and the other electrode of the pair forms one of a case of the display and a power terminal of a circuit arranged to drive and control the display, the electronics being further arranged to process the signal and to determine the near presence of a user and further to effect activation of the display accordingly in dependence of the presence of the user.
